(19) United States
(12) Patent Application Publication
(10) Pub. No.: US 2025/0036889 A1
(43) Pub. Date: Jan. 30, 2025

(54) METHOD OF IMPLEMENTING ARTIFICIAL INTELLIGENCE SMART VISUAL INTERPRETERS

(71) Applicant: BitHuman Inc

(72) Inventors: Yun Fu, Newton, MA (US); Steve Gu, Lafayette, CA (US)

(73) Assignee: BitHuman Inc, (omitted)

(21) Appl. No.: 18/227,142

(22) Filed: Jul. 27, 2023

(51) Int. Cl. G06F 40/58; G06T 11/00; G06T 13/20; G10L 25/57; G10L 25/78; H04N 21/43; H04N 21/488

(52) U.S. Cl. CPC G06F 40/58; G06T 11/00; G06T 13/205; G10L 25/57; G10L 25/78; H04N 21/43074; H04N 21/4884; G06F 3/012; G06F 3/013; G06F 3/041; H04R 1/406

(57) ABSTRACT

Embodiments of the present disclosure may include a method for a smart sign language translation service with a visual assistant with artificial intelligence.

### BACKGROUND OF THE INVENTION

Embodiments of a method for a smart sign language translation service with a visual assistant with artificial intelligence.

### BRIEF SUMMARY

Embodiments of the present disclosure may include a method for a smart sign language translation service with a visual assistant with artificial intelligence, the method including detecting, by one or more processors, a request from a user. In some embodiments, an artificial intelligence engine may be coupled to the one or more processors. In some embodiments, the artificial intelligence engine may be trained by human experts in the field.

In some embodiments, the virtual assistant may be configured to be displayed in LED/OLED displays, Android/iOS tablets, Laptops/PCs, or VR/AR goggles. In some embodiments, a set of multi-layer info panels coupled to the one or more processors may be configured to overlay graphics on top of the virtual assistant. In some embodiments, the visual assistant may be configured to be displayed as a human avatar or a cartoon character based on the user's choice.

In some embodiments, the virtual assistant may be configured to be displayed in full-body or half-body portrait mode. In some embodiments, the artificial intelligence engine may be configured for real-time speech recognition, speech-to-text generation, real-time dialog generation, text-to-speech generation, voice-driven animation, and human avatar generation.

In some embodiments, the artificial intelligence engine may be configured to emulate different voices and use different languages. In some embodiments, the human avatar may be configured to behave like a real human. In some embodiments, the human avatar may be configured to look like a real human. In some embodiments, the human avatar may be configured to have a unique personality out of a set of personalities.

In some embodiments, the human avatar may be configured to share ideas and information and guide the user depending the user's needs. In some embodiments, the human avatar may be configured to be generated in a human-sized glass, or tablet, or a wall-mounted tablet that can move and be adjusted by the user. In some embodiments, the human avatar may be configured to interact with the user via microphones, loud speaker, touch screen, front facing camera, wifi and bluetooth modules, adjustable holder &amp;.

Embodiments may also include wheels that may be coupled to the one or more processors. Embodiments may also include detecting, by the one or more processors and a set of sensors coupled to the one or more processors, an entering of the user into an encounter area. In some embodiments, the set of sensors monitors the encounter area in a pre-determined manner.

Embodiments may also include detecting and tracking the user's face, eye, and pose by a set of outward-facing cameras coupled to the one or more processors. In some embodiments, a set of touch screens coupled to the one or more processors may be configured to allow the user to interact with the visual assistant by hand. Embodiments may also include detecting the user's voice by a set of microphones coupled to the one or more processors.

In some embodiments, the set of microphones may be connected to loudspeakers. In some embodiments, the set of microphones may be enabled to be beamforming. Embodiments may also include extracting a character string in a text form from a caption of an original video when the user requests for translation of the text into sign language.

In some embodiments, the translation of the sign language has to be able to translate any combination of body gestures, hand gestures, facial expressions, micro-expressions, head pose and movements, and lip movements. In some embodiments, the text could be multilingual. In some embodiments, the sign language may be configured to be performed by the visual assistant with artificial intelligence.

Embodiments may also include translating the character string to a machine language by separating the character string based on a word space and a sentence identification symbol. Embodiments may also include separating the separated character string into morpheme units. Embodiments may also include translating morpheme units to machine language.

Embodiments may also include translating the machine language to actions of the visual assistant expressing sign language. In some embodiments, the actions of the visual assistant may be shown in a small window video on the smart display. Embodiments may also include synchronizing the original video with the small window video that the visual assistant expresses may be expressing sign language, and mixing the original video and the synchronized small window video. Embodiments may also include showing the original video with the small window video that the visual assistant expresses may be expressing sign language to the user. In some embodiments, the visual assistant may be configured to switch between sign language and multilingual oral language anytime and anywhere.

In some embodiments, the original video may be a real-time streaming video. In some embodiments, the artificial intelligence engine may be configured to detect that the user may have a hearing impairment and may be configured to activate the sign language translation. Embodiments may also include a method for a smart sign language translation service with a visual assistant with artificial intelligence, the method includes detecting, by one or more processors, a request from a user.

In some embodiments, an artificial intelligence engine may be coupled to the one or more processors. In some embodiments, the artificial intelligence engine may be trained by human experts in the field. In some embodiments, the virtual assistant may be configured to be displayed in LED/OLED displays, Android/iOS tablets, Laptops/PCs, or VR/AR goggles.

In some embodiments, a set of multi-layer info panels coupled to the one or more processors may be configured to overlay graphics on top of the virtual assistant. In some embodiments, the visual assistant may be configured to be displayed as a human avatar or a cartoon character based on the user's choice. In some embodiments, the virtual assistant may be configured to be displayed in full-body or half-body portrait mode.

In some embodiments, the artificial intelligence engine may be configured for real-time speech recognition, speech-to-text generation, real-time dialog generation, text-to-speech generation, voice-driven animation, and human avatar generation. In some embodiments, the artificial intelligence engine may be configured to emulate different voices and use different languages.

In some embodiments, the human avatar may be configured to behave like a real human. In some embodiments, the human avatar may be configured to look like a real human. In some embodiments, the human avatar may be configured to have a unique personality out of a set of personalities. In some embodiments, the human avatar may be configured to share ideas and information and guide the user depending on the user's needs.

In some embodiments, the human avatar may be configured to be generated in a human-sized glass, tablet, or a wall-mounted tablet that can move and be adjusted by the user. In some embodiments, the human avatar may be configured to interact with the user via microphones, loudspeakers, touch screen, front-facing camera, wifi and Bluetooth modules, adjustable holder &amp;.

Embodiments may also include wheels that may be coupled to the one or more processors. Embodiments may also include detecting, by the one or more processors and a set of sensors coupled to the one or more processors, an entering of the user into an encounter area. In some embodiments, the set of sensors monitors the encounter area in a pre-determined manner.

Embodiments may also include detecting and tracking the user's face, eye, and pose by a set of outward-facing cameras coupled to the one or more processors. In some embodiments, a set of touch screens coupled to the one or more processors may be configured to allow the user to interact with the visual assistant by hand. Embodiments may also include detecting the user's voice by a set of microphones coupled to the one or more processors.

In some embodiments, the set of microphones may be connected to loudspeakers. In some embodiments, the set of microphones may be enabled to be beamforming. Embodiments may also include showing a video with sign language that may be performed. Embodiments may also include translating sign language into different languages.

In some embodiments, the user can select one or more languages to be shown as captions on the screen. In some embodiments, the user can select to listen to any of the different languages. Embodiments may also include synchronizing the original video with the small window video that the visual assistant expresses sign language and the captions on the screen, and mixing the original video and the synchronized small window video and the captions on the screen. In some embodiments, the visual assistant may be configured to switch between sign language and multilingual oral language anytime and anywhere. Embodiments may also include showing the original video with the small window video and the captions on the screen with audio of the any of different languages selected by the user.

Embodiments of the present disclosure may also include, the method in claim 4. In some embodiments, the original video may be a real-time streaming video.

### BRIEF DESCRIPTION OF THE FIGURES

FIG. 1A is a flowchart illustrating a method, according to some embodiments of the present disclosure.

FIG. 1B is a flowchart extending from FIG. 1A and further illustrating the method, according to some embodiments of the present disclosure.

FIG. 2A is a flowchart illustrating a method, according to some embodiments of the present disclosure.

FIG. 2B is a flowchart extending from FIG. 2A and further illustrating the method, according to some embodiments of the present disclosure.

FIG. 3 is a diagram showing an example of a method of providing a smart sign language translation service with a visual assistant with artificial intelligence.

FIG. 4 is a diagram showing a second example of a method of providing a smart sign language translation service with a visual assistant with artificial intelligence.

FIG. 5 is a diagram showing a third example of a method of providing a smart sign language translation service with a visual assistant with artificial intelligence.

FIG. 6 is a diagram showing a fourth example of a method of providing a smart sign language translation service with a visual assistant with artificial intelligence.

### DETAILED DESCRIPTION

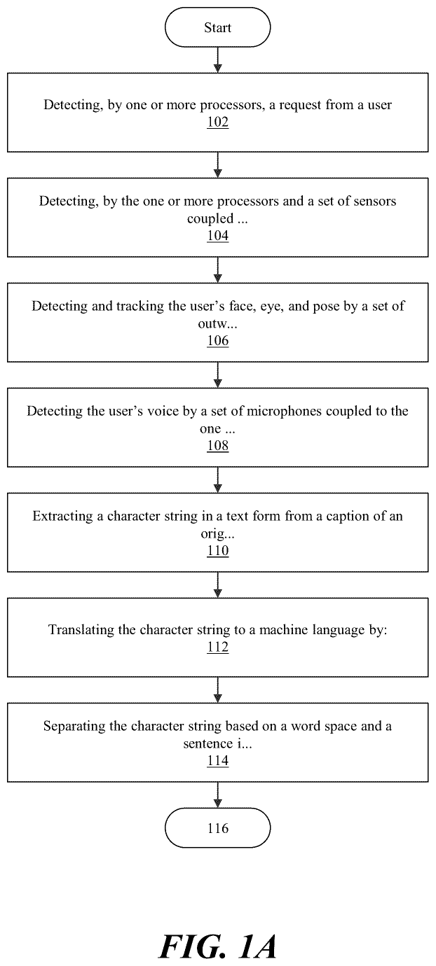

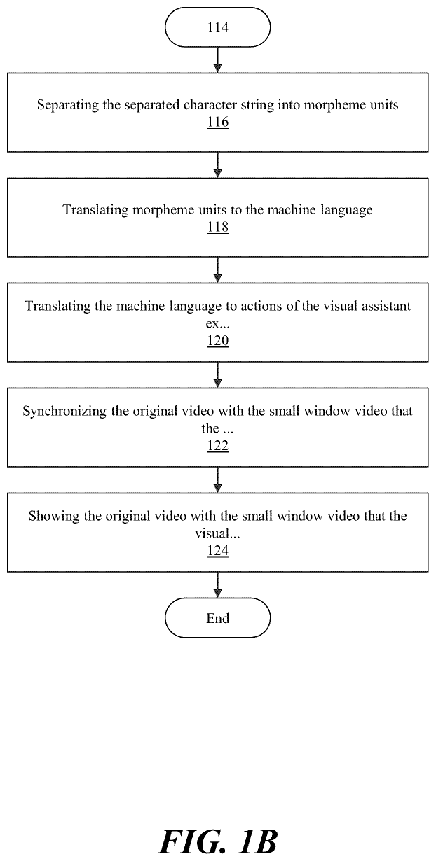

FIGS. 1A to 1B are flowcharts that describe a method, according to some embodiments of the present disclosure. In some embodiments, at 102, the method may include detecting, by one or more processors, a request from a user. At 104, the method may include detecting, by the one or more processors and a set of sensors coupled to the one or more processors, an entering of the user into an encounter area. At 106, the method may include detecting and tracking the user's face, eye, and pose by a set of outward-facing cameras coupled to the one or more processors.

In some embodiments, at 108, the method may include detecting the user's voice by a set of microphones coupled to the one or more processors. At 110, the method may include extracting a character string in a text form from a caption of an original video when the user requests for translation of the text into sign language. At 112, the method may include translating the character string to a machine language by: . At 114, the method may include separating the character string based on a word space and a sentence identification symbol.

In some embodiments, at 116, the method may include separating the separated character string into morpheme units. At 118, the method may include translating morpheme units to the machine language. At 120, the method may include translating the machine language to actions of the visual assistant expressing sign language. At 122, the method may include synchronizing the original video with the small window video that the visual assistant express may be expressing sign language, and mixing the original video and the synchronized small window video. At 124, the method may include showing the original video with the small window video that the visual assistant express may be expressing sign language to the user.

In some embodiments, an artificial intelligence engine may be coupled to the one or more processors. The artificial intelligence engine may be trained by human experts in the field. The virtual assistant may be configured to be displayed in LED/OLED displays, Android/iOS tablets, Laptops/PCs, or VR/AR goggles. A set of multi-layer info panels coupled to the one or more processors may be configured to overlay graphics on top of the virtual assistant.

In some embodiments, the visual assistant may be configured to be displayed as a human avatar or a cartoon character based on the user's choice. The virtual assistant may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. The human avatar may be configured to behave like a real human. The human avatar may be configured to look like a real human. The human avatar may be configured to have a unique personality out of a set of personalities. The human avatar may be configured to share ideas and information and guide the user depending the user's needs.

In some embodiments, the human avatar may be configured to be generated in a human-sized glass, or tablet, or a wall-mounted tablet that can move and be adjusted by the user. The human avatar may be configured to interact with the user via microphones, loud speaker, touch screen, front facing camera, wifi and bluetooth modules, adjustable holder &amp;. Wheels that may be coupled to the one or more processors. The set of sensors may monitor the encounter area in a pre-determined manner.

In some embodiments, a set of touch screens coupled to the one or more processors may be configured to allow the user to interact with the visual assistant by hand. The set of microphones may be connected to loudspeakers. The set of microphones may be enabled to be beamforming. The translation of the sign language may have to be able to translate any combination of body gestures, hand gestures, facial expressions, micro-expressions, head pose and movements, and lip movements. The text could be multilingual. The sign language may be configured to be performed by the visual assistant with artificial intelligence. The actions of the visual assistant may be shown in a small window video on the smart display. The visual assistant may be configured to switch between sign language and multilingual oral language anytime and anywhere. In some embodiments, the original video may be a real-time streaming video.

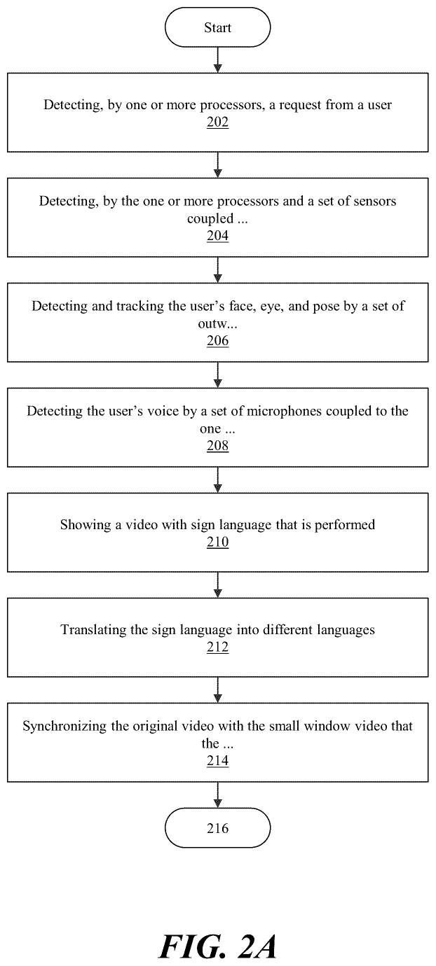

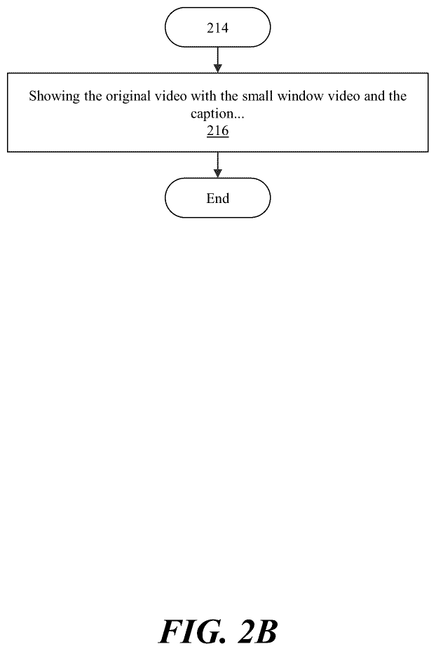

FIGS. 2A to 2B are flowcharts that further describe the method from FIG. 1A, according to some embodiments of the present disclosure. In some embodiments, the artificial intelligence engine may be configured to detect that the user may have hearing impairment, and may be configured to activate the sign language translation. 4. A method for a smart sign language translation service with a visual assistant with artificial intelligence, the method comprising, the method may include performing one or more additional steps. An artificial intelligence engine may be coupled to the one or more processors.

In some embodiments, the artificial intelligence engine may be trained by human experts in the field. The virtual assistant may be configured to be displayed in LED/OLED displays, Android/iOS tablets, Laptops/PCs, or VR/AR goggles. A set of multi-layer info panels coupled to the one or more processors may be configured to overlay graphics on top of the virtual assistant. The visual assistant may be configured to be displayed as a human avatar or a cartoon character based on the user's choice.

In some embodiments, the virtual assistant may be configured to be displayed in full-body or half-body portrait mode. The artificial intelligence engine may be configured for real-time speech recognition, speech-to-text generation, real-time dialog generation, text-to-speech generation, voice-driven animation, and human avatar generation. The artificial intelligence engine may be configured to emulate different voices and use different languages.

In some embodiments, the human avatar may be configured to behave like a real human. The human avatar may be configured to look like a real human. The human avatar may be configured to have a unique personality out of a set of personalities. The human avatar may be configured to share ideas and information and guide the user depending the user's needs. The human avatar may be configured to be generated in a human-sized glass, or tablet, or a wall-mounted tablet that can move and be adjusted by the user.

In some embodiments, the human avatar may be configured to interact with the user via microphones, loud speakers, touch screen, front-facing camera, wifi and Bluetooth modules, adjustable holder &amp;. Wheels that may be coupled to the one or more processors. The set of sensors may monitor the encounter area in a pre-determined manner. A set of touch screens coupled to one or more processors may be configured to allow the user to interact with the visual assistant by hand. The set of microphones may be connected to loudspeakers. The set of microphones may be enabled to be beamforming. The user can select one or more languages to be shown as captions on the screen. The user can select to listen to any of the different languages. The visual assistant may be configured to switch between sign language and multilingual oral language anytime and anywhere.

In some embodiments, the original video may be a real-time streaming video.

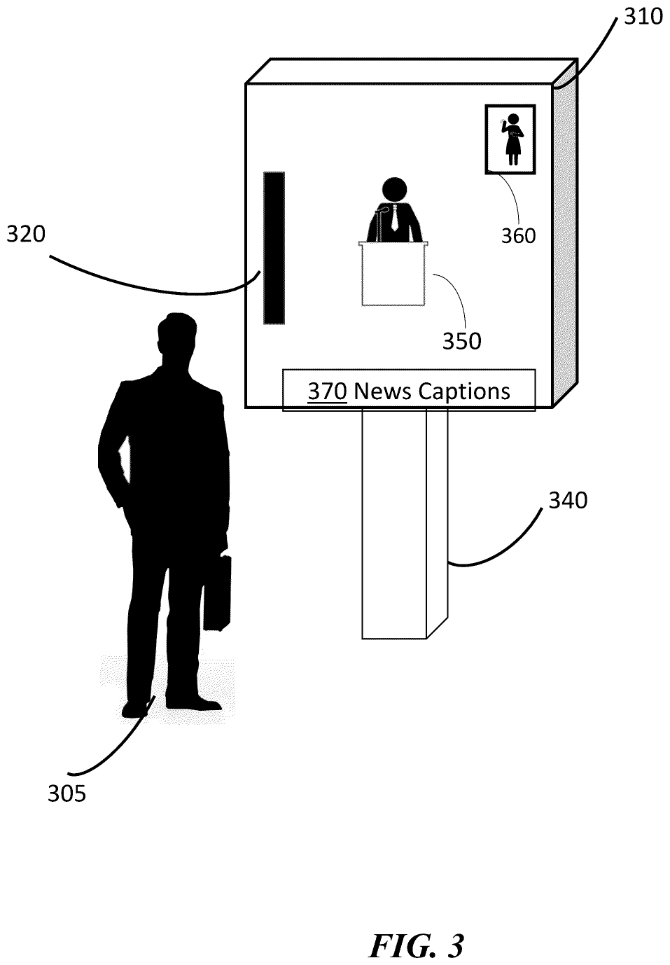

FIG. 3 is a diagram showing an example of a method of providing a smart sign language translation service with a visual assistant with artificial intelligence.

In some embodiments, a user 305 can approach a smart display 310. In some embodiments, the smart display 310 could be LED or OLED-based. In some embodiments, a support column 340 supports the smart display 310. In some embodiments, interactive panels 320 is attached to the smart display 310. In some embodiments, a news anchor 350 is broadcasting news, showing on the smart display 310. In some embodiments, news audio information can be interpreted to sign language by an AI-based visual assistant 360 in a small window on the smart display 310 by methods described in FIG. 1A, FIG. 1B, FIG. 2A and FIG. 2B. In some embodiments, news audio information broadcasted by the news anchor 350 can be translated into different language captions 370 by methods described in FIG. 1A, FIG. 1B, FIG. 2A and FIG. 2B. In some embodiments, interactive panel 320 is coupled to a central processor. In some embodiments, interactive panel 320 is coupled to a server via a wireless link. In some embodiments, user 305 can interact with the visual assistant 360 using methods described in FIG. 1A, FIG. 1B, FIG. 2A, and FIG. 2B, with the help of interactive panel 320. In some embodiments, user 305 can choose what sign language and what language captions should be used.

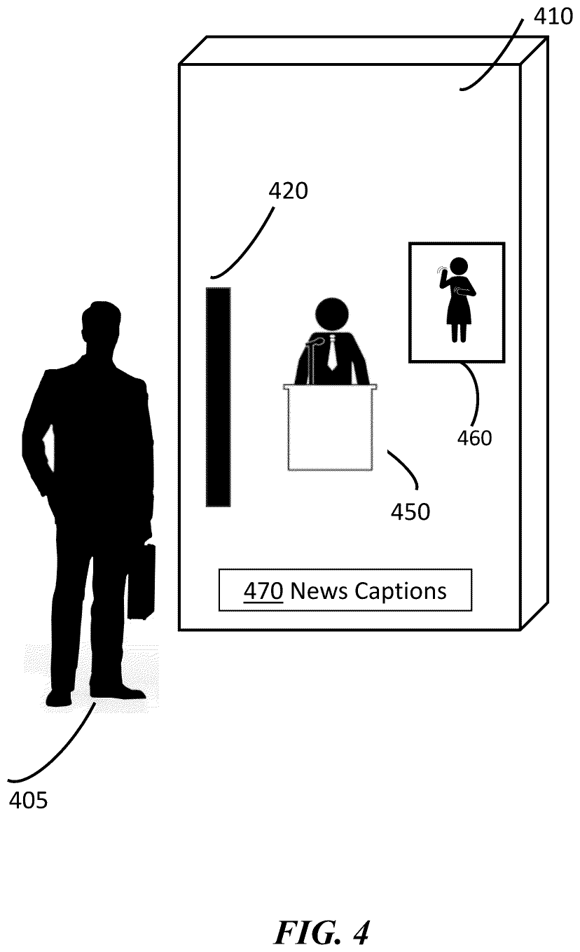

FIG. 4 is a diagram showing a second example of a method of providing a smart sign language translation service with a visual assistant with artificial intelligence.

In some embodiments, a user 405 can approach a smart display 410. In some embodiments, the smart display 410 could be LED or OLED-based. In some embodiments, interactive panels 420 are attached to the smart display 410. In some embodiments, a news anchor 450 is broadcasting news, showing on the smart display 410. In some embodiments, news audio information can be interpreted to sign language by an AI-based visual assistant 460 in a small window on the smart display 410 by methods described in FIG. 1A, FIG. 1B, FIG. 2A, and FIG. 2B. In some embodiments, news audio information broadcasted by the news anchor 450 can be translated into different language captions 470 by methods described in FIG. 1A, FIG. 1B, FIG. 2A and FIG. 2B. In some embodiments, interactive panel 420 is coupled to a central processor. In some embodiments, interactive panel 420 is coupled to a server via wireless link. In some embodiments, the user 405 can interact with the visual assistant 460 using methods described in FIG. 1A, FIG. 1B, FIG. 2A, and FIG. 2B, with the help of interactive panel 420. In some embodiments, user 405 can choose what sign language and what language captions should be used.

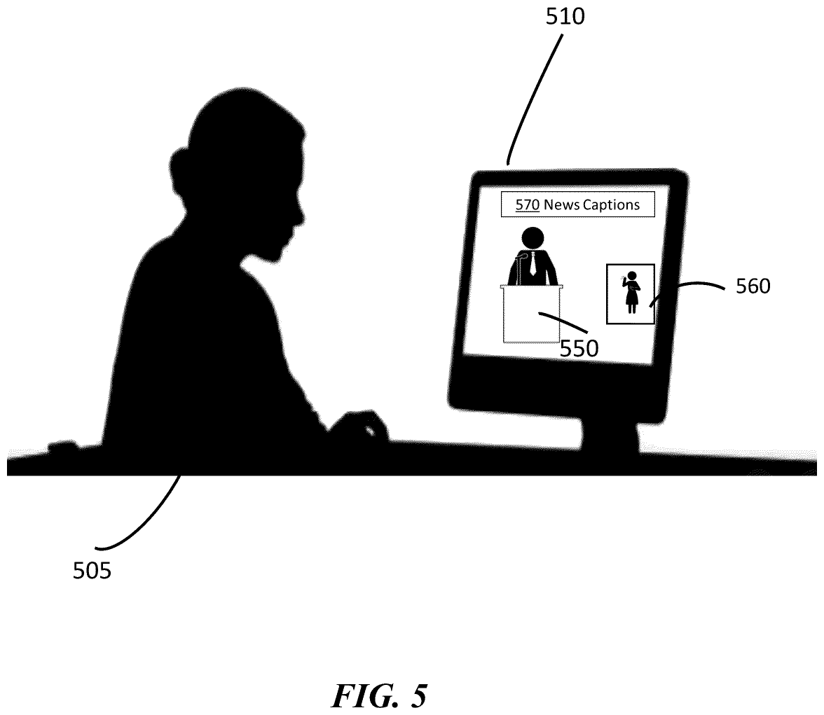

FIG. 5 is a diagram showing a third example of a method of providing a smart sign language translation service with a visual assistant with artificial intelligence.

In some embodiments, a user 505 can view news or other content and interact with a smart display 510. In some embodiments, the smart display 510 could be LED or OLED-based. In some embodiments, a processor and a server are connected to the smart display 510. In some embodiments, an interactive keyboard is attached to the smart display 510. In some embodiments, a news anchor 550 is broadcasting news, showing on the smart display 510. In some embodiments, news audio information can be interpreted to sign language by an AI-based visual assistant 560 in a small window on the smart display 510 by methods described in FIG. 1A, FIG. 1B, FIG. 2A, and FIG. 2B. In some embodiments, news audio information broadcasted by the news anchor 550 can be translated into different language captions 570 by methods described in FIG. 1A, FIG. 1B, FIG. 2A and FIG. 2B. In some embodiments, an interactive panel is coupled to a central processor. In some embodiments, an interactive panel is coupled to a server via a wireless link. In some embodiments, the user 505 can interact with the visual assistant 560 using methods described in FIG. 1A, FIG. 1B, FIG. 2A, and FIG. 2B, with the help of interactive panel 520. In some embodiments, the user 505 can choose what sign language and what language captions should be used.

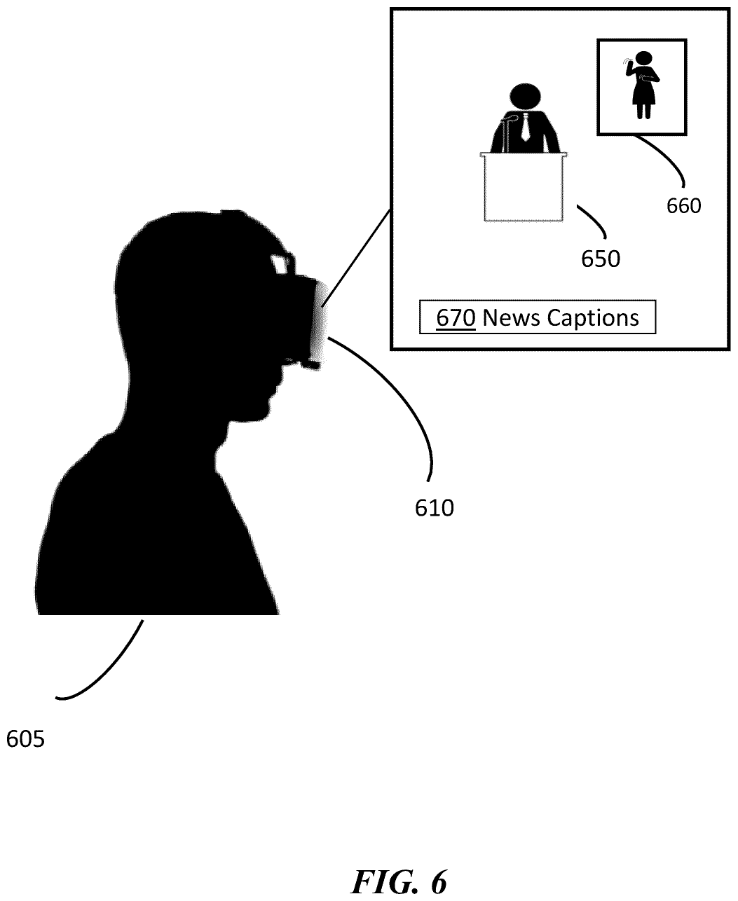

FIG. 6 is a diagram showing a fourth example of a method of providing a smart sign language translation service with a visual assistant with artificial intelligence.

In some embodiments, a user 605 can view programs including news with a VR or AR device 610. In some embodiments, a processor and a server are connected to the VR or AR device 610. In some embodiments, an interactive keyboard is connected to the VR or AR device 610. In some embodiments, a news anchor 650 is broadcasting news, showing on the VR or AR device 610. In some embodiments, news audio information can be interpreted to sign language by an AI-based visual assistant 660 in a small window on VR or AR device 610 by methods described in FIG. 1A, FIG. 1B, FIG. 2A and FIG. 2B. In some embodiments, news audio information broadcasted by the news anchor 650 can be translated into different language captions 670 by methods described in FIG. 1A, FIG. 1B, FIG. 2A and FIG. 2B. In some embodiments, an interactive panel is coupled to a central processor. In some embodiments, interactive panel is coupled to a server via a wireless link. In some embodiments, the user 605 can choose what sign language and what language captions should be used.

1. A method for a smart sign language translation service with a visual assistant with artificial intelligence, the method comprising:
detecting, by one or more processors, a request from a user, wherein an artificial intelligence engine is coupled to the one or more processors, wherein the artificial intelligence engine is trained by human experts in the field, wherein the virtual assistant is configured to be displayed in LED/OLED displays, Android/iOS tablets, Laptops/PCs, or VR/AR goggles, wherein a set of multi-layer info panels coupled to the one or more processors are configured to overlay graphics on top of the virtual assistant, wherein the visual assistant is configured to be displayed as a human avatar or a cartoon character based on the user's choice, wherein the virtual assistant is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein the human avatar is configured to behave like a real human, wherein the human avatar is configured to look like a real human, wherein the human avatar is configured to have a unique personality out of a set of personalities, wherein the human avatar is configured to share ideas and information and guide the user depending the user's needs, wherein the human avatar is configured to be generated in a human-sized glass, or tablet, or a wall-mounted tablet that can move and be adjusted by the user, wherein the human avatar is configured to interact with the user via microphones, loud speaker, touch screen, front facing camera, wifi and bluetooth modules, adjustable holder & wheels that are coupled to the one or more processors;
detecting, by the one or more processors and a set of sensors coupled to the one or more processors, an entering of the user into an encounter area, wherein the set of sensors monitor the encounter area in a pre-determined manner;
detecting and tracking the user's face, eye, and pose by a set of outward-facing cameras coupled to the one or more processors, wherein a set of touch screens coupled to the one or more processors is configured to allow the user to interact with the visual assistant by hand;
detecting the user's voice by a set of microphones coupled to the one or more processors, wherein the set of microphones are connected to loudspeakers, wherein the set of microphones are enabled to be beamforming;
extracting a character string in a text form from a caption of an original video when the user requests for translation of the text into sign language, wherein the translation of the sign language has to be able to translate any combination of body gestures, hand gestures, facial expressions, micro-expressions, head pose and movements, and lip movements, wherein the text could be multilingual, wherein the sign language is configured to be performed by the visual assistant with artificial intelligence;
translating the character string to a machine language by:
separating the character string based on a word space and a sentence identification symbol,
separating the separated character string into morpheme units, and
translating morpheme units to the machine language;
translating the machine language to actions of the visual assistant expressing sign language, wherein the actions of the visual assistant are shown in a small window video on the smart display
synchronizing the original video with the small window video that the visual assistant express is expressing sign language, and mixing the original video and the synchronized small window video;
showing the original video with the small window video that the visual assistant express is expressing sign language to the user, wherein the visual assistant is configured to switch between sign language and multilingual oral language anytime and anywhere.

2. The method in claim 1, wherein the original video is a real-time streaming video.

3. The method in claim 1, wherein the artificial intelligence engine is configured to detect that the user may have hearing impairment, and is configured to activate the sign language translation.

4. A method for a smart sign language translation service with a visual assistant with artificial intelligence, the method comprising:
detecting, by one or more processors, a request from a user, wherein an artificial intelligence engine is coupled to the one or more processors, wherein the artificial intelligence engine is trained by human experts in the field, wherein the virtual assistant is configured to be displayed in LED/OLED displays, Android/iOS tablets, Laptops/PCs, or VR/AR goggles, wherein a set of multi-layer info panels coupled to the one or more processors are configured to overlay graphics on top of the virtual assistant, wherein the visual assistant is configured to be displayed as a human avatar or a cartoon character based on the user's choice, wherein the virtual assistant is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein the human avatar is configured to behave like a real human, wherein the human avatar is configured to look like a real human, wherein the human avatar is configured to have a unique personality out of a set of personalities, wherein the human avatar is configured to share ideas and information and guide the user depending the user's needs, wherein the human avatar is configured to be generated in a human-sized glass, or tablet, or a wall-mounted tablet that can move and be adjusted by the user, wherein the human avatar is configured to interact with the user via microphones, loud speaker, touch screen, front facing camera, wifi and bluetooth modules, adjustable holder & wheels that are coupled to the one or more processors.
detecting, by the one or more processors and a set of sensors coupled to the one or more processors, an entering of the user into an encounter area, wherein the set of sensors monitor the encounter area in a pre-determined manner;
detecting and tracking the user's face, eye, and pose by a set of outward-facing cameras coupled to the one or more processors, wherein a set of touch screens coupled to the one or more processors is configured to allow the user to interact with the visual assistant by hand;
detecting the user's voice by a set of microphones coupled to the one or more processors, wherein the set of microphones are connected to loudspeakers, wherein the set of microphones are enabled to be beamforming;
showing a video with sign language that is performed;
translating the sign language into different languages, wherein the user can select one or more languages to be shown as captions on the screen, wherein the user can select to listen to any of the different languages;
synchronizing the original video with the small window video that the visual assistant expresses sign language and the captions on the screen, and mixing the original video and the synchronized small window video and the captions on the screen, wherein the visual assistant is configured to switch between sign language and multilingual oral language anytime and anywhere; and
showing the original video with the small window video and the captions on the screen with audio of the any of different languages selected by the user.

5. The method in claim 4, wherein the original video is a real-time streaming video.
